(19) United States
(12) Patent Application Publication
(10) Pub. No.: US 2002/0017301 A1
(43) Pub. Date: Feb. 14, 2002

(54) Pressure relief valve

(75) Inventor: Bo Lundin, Taby (SE)

Correspondence Address: SCHIFF HARDIN & WAITE, 6600 SEARS TOWER, 233 S WACKER DR, CHICAGO, IL, 60606-6473, US

(73) Assignee: Siemens Elema AB

(21) Appl. No.: 09/891,940

(22) Filed: Jun. 26, 2001

(30) Foreign Application Priority Data
Aug. 1, 2000 (SE) 0002805-0

(51) Int. Cl. A62B 18/10; A62B 9/02

(52) U.S. Cl. 128/205.24; 128/201.28

(57) ABSTRACT

A fluid pressure relief valve has an aperture for the flow through of a fluid, the aperture being disposed between a fluid inlet and a fluid outlet. A movably mounted valve element is disposed for pressure communication with the fluid and is movable to unseal the aperture when an opening force exerted by the communicated fluid pressure on the valve element exceeds a counteracting threshold force. A biasing source provides a bias force for moving the valve element toward sealing the aperture. The valve element is disposed for pressure communication with the fluid such that a closing force less than and counter to the opening force is additionally exerted on the valve element by the communicated fluid pressure. This force in combination with the bias force generates the threshold force.

### BACKGROUND OF THE INVENTION

1. Field of the Invention

The present invention relates to a pressure relief valve and in particular to a relief valve for regulating positive end expiratory pressure (PEEP) levels within a patient breathing circuit of a mechanical breathing assist device.

2. Description of the Prior Art

A pressure relief valve is a valve which exhibits a threshold resistance such that no fluid can flow through the valve until the fluid pressure equals a predetermined threshold value. At this time an opening force exerted by the fluid pressure on a valve element equals a counteracting threshold closing force exerted by an actuator on the valve element. Above the threshold pressure it is important that the valve should allow high rates of fluid flow without any significant increase in pressure drop across the valve. This is because such a valve is typically employed to open under conditions critical to safety where transfer of fluid pressure other than through the valve could have serious consequences. This is particularly true when the pressure relief valve is used as a safety valve within a patient breathing circuit. A pressure relief valve may also can be employed within such a breathing circuit as a PEEP valve to control the positive end expiratory pressure and typically should be able to permit the flow through of expiration gas at flow rates of up to 200 to 300 liters per minute without a significant increase in the pressure drop.

A pressure relief valve, such as a PEEP valve, typically has an aperture for the flow through of a fluid toward which a moveably mounted valve element is urged with a predetermined threshold closing force generated by a biasing means. The valve element is a arranged with a sealing surface which co-operates with the aperture to regulate the flow through of fluid and which can seal against the aperture with the predetermined closing force. The sealing surface is disposed, for pressure communication with the fluid, to be movable in the direction of the fluid flow to unseal the aperture when an opening force exerted by the communicated fluid pressure exceeds the counter-acting closing force.

In such a known pressure relief valve, all of the predetermined closing force is generated by the biasing means, therefore relatively large and powerful biasing means are required. Such biasing means are often space consuming and if formed by a solenoid, often consume a significant amount of energy as well. Moreover, such biasing means are relatively expensive to produce.

It is known from U.S. Pat. No. 6,082,705 to provide a flow regulation valve in which fluid, the flow of which is to be regulated, is used to seal the valve in the absence of an opening force provided by a biasing element. The valve has a valve housing with a fluid inlet and a fluid outlet between which is disposed a valve face. The valve face has a valve aperture adjacent to which is a movable sealing element which is movable by an opening force exerted by the fluid in the direction of fluid flow to unseal the aperture. A biasing element is provided to control the position of the sealing element and to regulate the flow of fluid through the valve. A duct is provided to divert a portion of the fluid to act on a side of the sealing element facing away from the aperture and thus provide a closing force on the element counter to and at least as large as the opening force exerted by the fluid. In the absence of an opening force from the biasing element this will cause the element to move to seal the aperture.

### SUMMARY OF THE INVENTION

It is an object of the present invention to provide a pressure relief valve in which the use of a less powerful biasing element can be employed without reducing the threshold pressure of fluid required to open the valve.

The above object is achieved in accordance with the principles of the present invention in a fluid pressure relief valve having an aperture through which a fluid flows, a movably mounted valve element disposed for pressure communication with the fluid and being movable to unseal the aperture when an opening force exerted by the fluid pressure on the valve element exceeds a counteracting threshold force, a biasing arrangement which provides the aforementioned bias force, in a direction for moving the valve element toward sealing the aperture, and wherein the pressure communication between the valve element and the fluid is such that a closing force, less than and counter to the opening force, is additionally exerted on the valve element by the fluid pressure, with this additional force and the bias force generating the threshold force.

Arranging for the valve element to be in pressure communication with the fluid causes both an opening force and a smaller closing force are produced on the valve element by the fluid pressure. This means that the biasing element need only be powerful enough to contribute a bias force which is the difference between the closing force generated by the fluid pressure and a predetermined threshold force which must be matched by the opening force generated by the fluid pressure as it reaches a predetermined threshold pressure before fluid pressure is relieved by the valve.

The biasing element can generate a variable bias force. The valve element can have a first surface and a smaller second surface over which surfaces the fluid pressure acts and which are mechanically connected and disposed to define opposing end wall portions of a fluid receiving chamber. This chamber contains the aperture for the flow through of the fluid which is sealable by the first surface when moved against the direction of flow through of the fluid. This achieves a relatively simple valve construction. Moreover, by using the larger surface to seal the aperture then the aperture can be dimensioned to provide sufficient flow through of fluid without a significant increase in the size of the valve.

Preferably, the valve is adapted to receive expiration gas from within an expiration line of a patient breathing circuit and to provide a PEEP level within the breathing circuit which may be made adjustable by providing a bias element capable of providing a variable bias force.

### DESCRIPTION OF THE DRAWINGS

FIG. 1 is a schematic illustration of an embodiment of the pressure relief valve according to the present invention.

FIG. 2 is a schematic illustration of a further embodiment of the pressure relief valve according to the present invention.

FIG. 3 is a schematic illustration of a patient breathing circuit according to the present invention.

### DESCRIPTION OF THE PREFERRED EMBODIMENTS

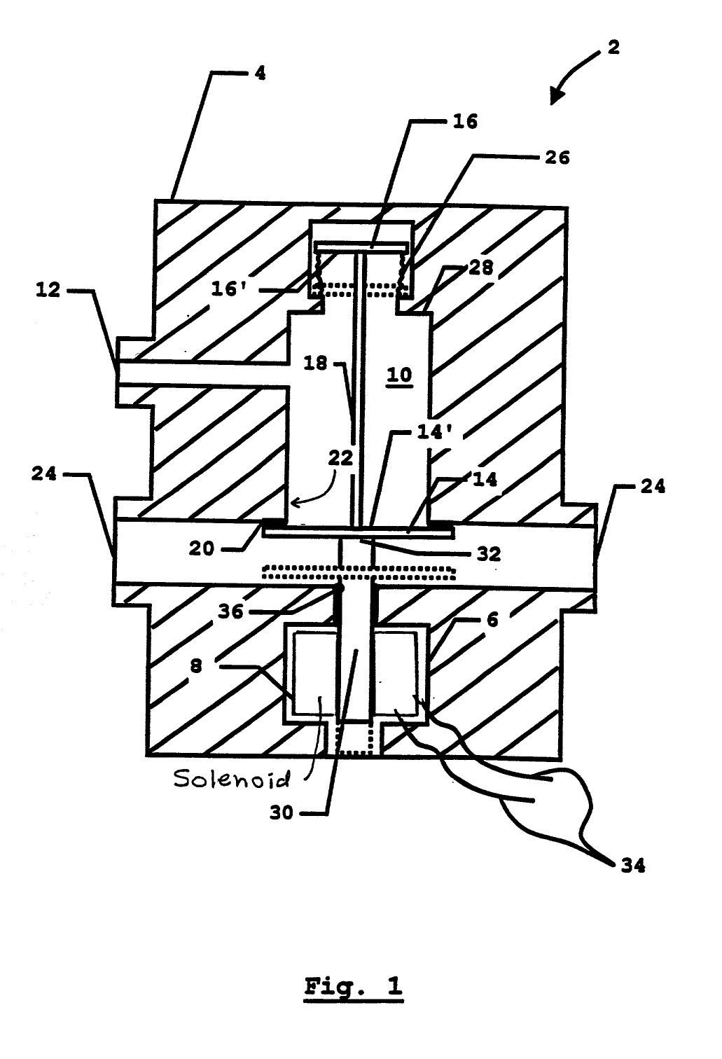

As shown in FIG. 1, an embodiment of a pressure relief valve 2 according to the present invention is illustrated partly in section. The valve 2 has a valve housing 4 having integrated with a solenoid housing 6 in which is housed a solenoid 8. The valve housing 4 encloses a fluid receiving chamber 10 which communicates with the exterior of the valve housing 4 via an inlet 12 through which fluid, such as an inspiration or an expiration gas, can be received into the chamber 10. The chamber 10 has opposing wall sections defined by a movable first plate 14 and a movable second plate 16 which are mechanically connected by a rigid member 18 so that they are movable in concert. The first plate 14 has a first surface 14′ exposed to fluid pressure within the chamber 10 and the second plate 16 has a second surface 16′ which is also exposed to the same fluid pressure. The area A1 of the first surface 14′ is greater than the area A2 of the second surface 16′. The first plate 14 is movable to seal (solid lines in FIG. 1) and unseal (broken lines in FIG. 1) against a sealing ring 20 located around a periphery of an aperture 22 in the chamber 10. The aperture 22 is connected to an outlet 24 through which fluid can exit the valve 2. The second plate 16 forms a rigid end wall of a collapsible wall section 26, the opposite end of which is sealed to a rigid wall section 28 of the chamber 10. The collapsible wall section 26 is arranged such that it is in an expanded state (as shown in FIG. 1) when the first plate 14 seals against the sealing ring 20 and is in a collapsed state when the plate 14 moves to unseal the aperture 22. A magnetically susceptible shaft 30 has an end 32 connected to the plate 14 and acts as a movable core of the solenoid 8 such that by passing a current through the solenoid 8 via leads 34 the shaft 30 can urge the plate 14 toward the aperture 20 with a bias force Fb, determined by the magnitude of the current flowing through the leads 34. Thus by varying the current through the leads 34 the bias force Fb, can be varied. A sealing ring 36 is provided to prevent any leakage of fluid from the outlet 24 to the solenoid housing 6.

In use fluid at a pressure P enters the chamber 10 and produces a force, F1 on the first surface 14′ of the first plate 14 having an area A1 over which the pressure P acts. The force, F1, is calculated as:

F1=P·A1 1)

This force F1 acts on the first plate 14 to provide an opening force tending to unseal the aperture 22.

Simultaneously, the fluid pressure P acts on the smaller surface 16′ of the second plate 16 which has an area A2, less than A1, to produce a force F2 on the plate 16. The force F2 is calculated as:

F2=P·A2 (2)

The force F2, because of the rigid connecting member 18, acts on the second plate 16 to provide a closing force on the first plate 14.

The closing force F2, and the bias force Fb, combine to generate a threshold force Ft which the opening force F1 must reach before the plate 14 can move under the influence of a threshold fluid pressure to unseal the aperture 22 and relieve the fluid pressure. The threshold force Ft is then:

Ft=F2+Fb=F1 (3)

Thus, if the valve of FIG. 1 is used as a PEEP valve so that pressures above a selected PEEP pressure P(PEEP) cause the plate 14 to unseal the aperture 22 then the valve 2 must be devised such that from equations (1) to (3):

Fb=(A1−A2)·P(PEEP) (4)

Since it is reasonable to expect the areas A1,A2 of the plates 14,16 are known or readily obtainable and fixed, then equation (4) can be used to calculate the necessary bias force Fb which the solenoid 8 must generate. This is less than the force which the solenoid 8 of known valves must generate since a part of the threshold force Ft in the valve 2 of the present invention is generated by the fluid pressure itself, acting on the smaller plate 16.

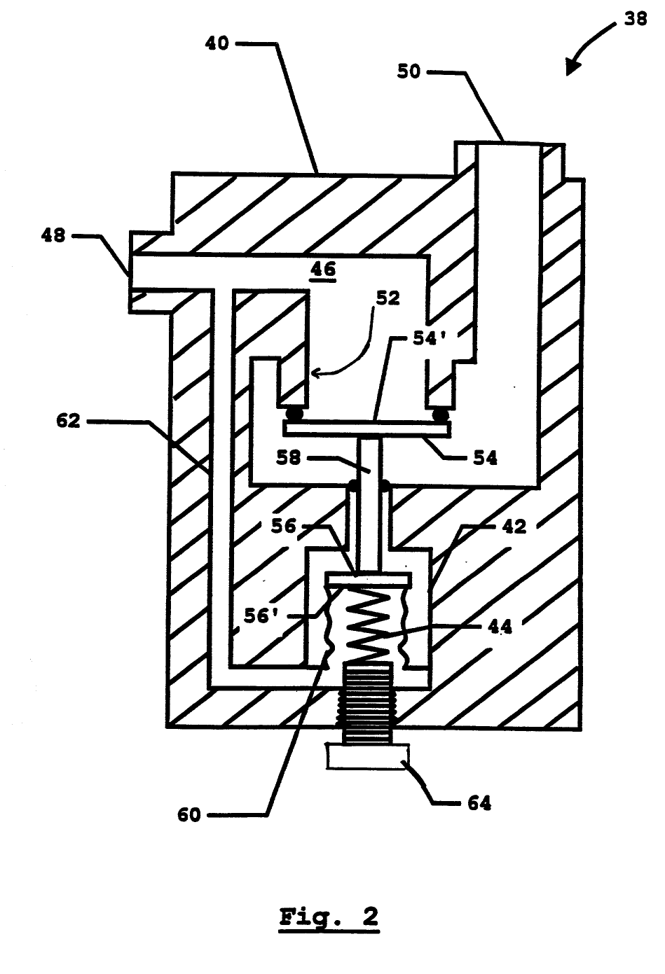

Considering now FIG. 2, a further embodiment of a pressure relief valve 38 according to the present invention is illustrated partly in section. The valve 38 has a valve housing 40 integrated with a spring housing 42 in which is housed a bias spring means 44. The valve housing 40 encloses a fluid duct which is connected an externally accessible inlet 48 to an externally accessible outlet 50. An aperture 52 for the flow through of fluid is disposed within the duct 46 between the inlet 48 and the outlet 50 and is sealable by a first movable plate 54 which is located directly in front of the outlet aperture 52 in the fluid flow direction through the valve 38, from inlet 48 to outlet 50 and is movable to seal and unseal the aperture 54. The first plate 54 is mechanically connected to a second movable plate 56 via a rigid rod 58 so that the two plates 54,56 can only move in concert. As in FIG. 1 the first plate 54 has a first surface 54′ and the second plate 56 has a smaller second surface 56′ over which the fluid pressure acts. The second plate 56 is located within the spring housing 42 and is operably connected to the spring 44 such that a bias force Fb′, which is generated by the compression of the spring 44, is transmitted via the second plate 56 and the rod 58 to the first plate 54 to urge the plate 54 toward sealing the aperture 52. Also located within the spring housing 42 is a variable volume container 60 which is sealed at one end to the second plate 56 so as to vary its volume as the second plate 56 moves and encloses the spring 44. The interior of the container 60 is in fluid communication with the fluid duct 46 by a bypass duct 62. In this manner the second, smaller plate 56 is placed in pressure communication with fluid in the fluid duct 46, the pressure of which is to be regulated by the valve 38, only on one side of the plate 56.

The second surface 56′ of the plate 56 has an area A2′ and is urged upwardly when exposed to a fluid at a pressure P′ with a closing force F2′, as given by substitution into equation (2). The same fluid pressure within the fluid duct 46 generates an opening force F1′ on the first plate 54 whose first surface 54′, has an area A1′ at a level given by substitution into equation (1). If the valve 38 is to function as a PEEP valve operating at a pressure P′(PEEP) then the bias force Fb′ necessarily provided by the spring 44 is, from equation (4):

Fb′=(A1′−A2′)·P′(PEEP) (5)

The required bias force Fb′ can be obtained by varying the compression of the spring 44 by rotating a threaded knob 64 attached to an end of the spring 44 either manually or automatically.

It will be appreciated by those skilled in the art that other known biasing arrangements can be substituted for those 8,44 described in FIG. 1 and FIG. 2 and that the described biasing arrangements 8,44 can be substituted for one another without departing from the invention. Indeed, it may be preferable for safety reasons to substitute the solenoid 8 of the valve 2 of FIG. 1 for a spring bias if the valve is used as a safety pressure release valve as a break in supply to the solenoid 8 may cause the valve to malfunction under safety critical conditions. Moreover, it will be further appreciated that the valve according to the present invention can be simply modified without departing from the invention so that as an alternative the second, smaller, movable plate 16, 56 is movable to seal and unseal a through flow aperture.

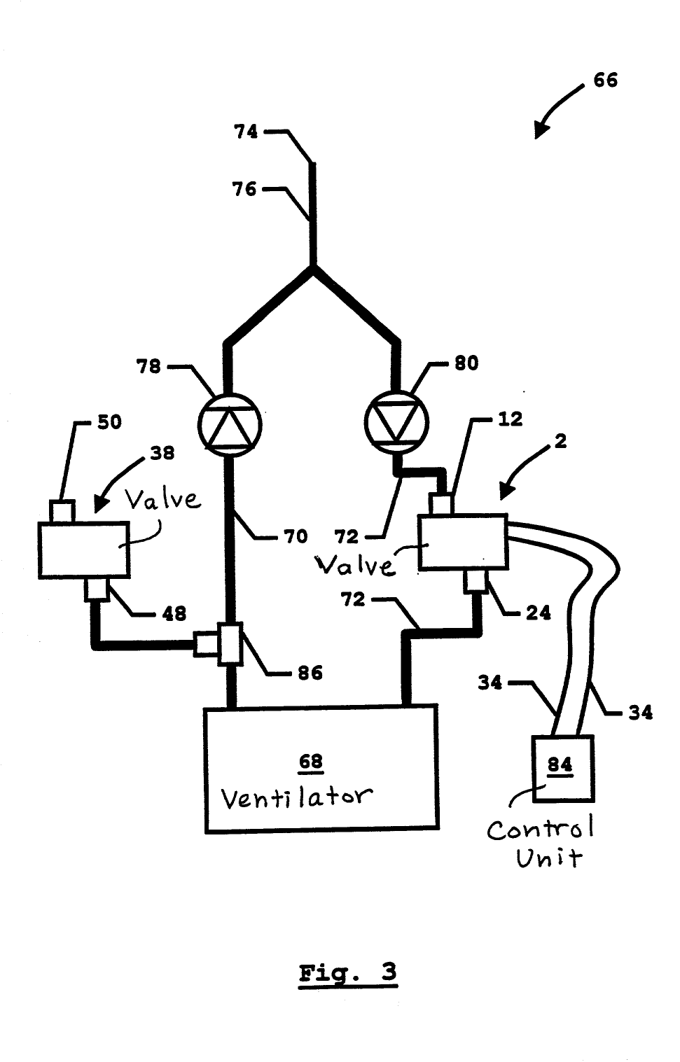

FIG. 3 shows an embodiment of a patient breathing circuit 66 according to the present invention. The illustrated breathing circuit 66 represents a circuit as is generally known in the art which includes a known PEEP valve. An inventive difference of the breathing circuit 66 of FIG. 3 is that the known PEEP valve is substituted for a PEEP valve according to the present invention, for example a valve 2,38 according to the above described exemplary embodiments. For this reason the breathing circuit 66 need not be described in great detail.

The breathing circuit 66 has a ventilator unit 68 to which ends of an inspiration gas line 70 and an expiration gas line 72 are connected for the transportation of gas respectively to and from an open end 74 of a patient tube 76, which open end 74 is intended in use to connect to the airways of a patient (not shown). One-way valves 78, 80 are respectively connected in-line in an inspiration line 70 and an expiration line 72 to ensure gas flows within the inspiration line 70 only in a direction toward the open end 74 and in the expiration line 72 only in a direction from the open end 74. A PEEP valve 2 according to the present invention is arranged in-line with the expiration line 72 with its inlet 12 connected to the expiration line 72 between the one way valve 80 and the ventilator 68 and its outlet 24 is connected via the expiration line 72 to the ventilator 68. The gas pressure within the expiration line 72 which will cause the valve 2 to open is controlled by current supplied by a control unit 84 (which may be incorporated within the ventilator 68) along leads 34 and is set so that the aperture 22 will remain unsealed until the pressure of the expiration gas falls to the PEEP level. A second relief valve 38 is incorporated in the inspiration line 70 and is arranged to act as a pressure release safety valve which operates to ensure that the pressure of inspiration gas supplied to the open end 74 does not exceed a predetermined safe maximum which may be set by adjusting the knob 64 (see FIG. 2) of the valve 38 to vary the extension of the spring bias 44 (see FIG. 2). To this end, and different to the PEEP valve 2 connection with the expiration line 72, only the inlet 48 of the valve 38 is connected (such as via a T-piece 86) to the inspiration line 70 with the outlet 50 venting to atmosphere (or a recovery system—not shown). In this configuration the aperture 52 will remain sealed until the inspiration gas pressure within the valve 38 exceeds a threshold set at the safe maximum value. Until this threshold is exceeded the inspiration gas continues to flow from the ventilator 68, along the inspiration line 70 and to the open end 74 of the patient tube 76.

It will be appreciated that the identical valves 2 or 38 may be used in the inspiration line 70 and the expiration line 72 of the breathing circuit 66 or that the valves 2 and 38 may be interchanged to provide the functionality described above with respect to FIG. 3 without departing from the invention. Additionally or alternatively a valve 2, 38 according to the present invention may be included in-line in the inspiration line 70 and arranged in a manner similar to that shown for valve 2 in the expiration line 72 of FIG. 3 to act as a lower pressure delimiter for gas supplied from the ventilator unit 68.

Although modifications and changes may be suggested by those skilled in the art, it is the intention of the inventor to embody within the patent warranted hereon all changes and modifications as reasonably and properly come within the scope of his contribution to the art.

I claim as my invention:

1. A fluid pressure relief valve comprising:
a valve housing having an aperture through which a fluid flows;
a movably mounted valve element disposed in said aperture for pressure communication with said fluid;
a biasing arrangement which generates a bias force acting on said valve element to bias said valve element to seal said aperture; and
said valve element being in pressure communication with said fluid so that if an opening force, exerted on said valve element by fluid pressure communicated from said fluid, exceeds a counteracting threshold force, said valve element is moved to unseal said aperture, and said pressure communication with said fluid also producing a closing force on said valve element, less than and counter to said opening force, said closing force in combination with said bias force generating said threshold force.

2. A pressure relief valve as claimed in claim 1 wherein said valve element has a first surface with a first surface area and a second surface with a second surface area, said second surface area being smaller than said first surface area, said first and second surfaces being disposed so that said fluid pressure is communicated across said first surface to generate said opening force and is communicated across said second surface to generate said closing force.

3. A pressure relief valve as claimed in claim 2 wherein said valve element comprises a first member having said first surface and a second member having said second surface, said first and second members being spaced from each other and being mechanically connected to each other, said first surface being movable to seal and unseal said aperture.

4. A pressure relief valve as claimed in claim 3 wherein said housing contains a fluid receiving chamber, in which said first and second members are disposed to defined opposing end wall portions of said chamber, and said chamber having a fluid inlet in said housing disposed intermediately between said opposing end walls.

5. A pressure relief valve as claimed in claim 3 wherein said first and second members are respective plates, and wherein said valve element comprises a rigid connecting member mechanically connecting said plates.

6. A pressure relief valve as claimed in claim 1 wherein said biasing arrangement is controllable to adjust said bias force.

7. A pressure relief valve as claimed in claim 6 wherein said biasing arrangement is a solenoid.

8. A pressure relief valve as claimed in claim 6 wherein said biasing arrangement comprises:
a spring;
a linkage mechanically connecting said spring to said valve element to apply a spring force to said valve element as said bias force; and
a threaded rod proceeding through threads in said housing and engaging said spring, said threaded rod being selectively rotatable to vary said spring force.

9. A patient breathing circuit comprising:
an inspiration line and an expiration line adapted for connection to a patient; and
a pressure relief valve connected in at least one of said inspiration line and said expiration line, said pressure relief valve comprising a valve housing having an aperture through which a fluid flows, a movably mounted valve element disposed in said aperture for pressure communication with said fluid, a biasing arrangement which generates a bias force acting on said valve element to bias said valve element to seal said aperture, and said valve element being in pressure communication with said fluid so that if an opening force, exerted on said valve element by fluid pressure communicated from said fluid, exceeds a counteracting threshold force, said valve element is moved to unseal said aperture, and said pressure communication with said fluid also producing a closing force on said valve element, less than and counter to said opening force, said closing force in combination with said bias force generating said threshold force.

10. A patient breathing circuit as claimed in claim 9 wherein said pressure relief valve is connected in said expiration line, and wherein said communicated fluid pressure is a positive end expiratory pressure in said expiration line.
